(19) United States
(12) Patent Application Publication
(10) Pub. No.: US 2010/0306945 A1
(43) Pub. Date: Dec. 9, 2010

(54) DEVICE FOR CLEANING THE ORAL CAVITY

(76) Inventor: Thomas Methfessel, Kempten (DE)

Correspondence Address: BACHMAN & LAPOINTE, P.C., 900 CHAPEL STREET, SUITE 1201, NEW HAVEN, CT, 06510, US

(21) Appl. No.: 12/812,474

(22) PCT Filed: Jan. 2, 2009
(86) PCT No.: PCT/DE2009/000001

§ 371 Date: Aug. 23, 2010

(30) Foreign Application Priority Data
Jan. 10, 2008 (DE) 20 2008 000 384.9

(51) Int. Cl. A61C 17/00

(52) U.S. Cl. 15/208

(57) ABSTRACT

A device for cleaning the oral cavity, having the basic form (1) of a thimble. In order that the same cannot simply slide off the finger, and thereby also remain hygienic even after multiple uses, the base form (1) has a flexibly designed locking feature (4).

### BACKGROUND OF THE INVENTION

The present invention relates to a device for cleaning the oral cavity, having the basic form of a thimble.

Devices of this kind for cleaning the oral cavity are already known and commonly used in a wide variety of shapes and designs. Cleaning the oral cavity, particularly the teeth and gums, is increasingly important at the present time. Ever greater demands in terms of efficiency and hygiene are placed on the devices used.

DE 102 15 805 C1, for example, discloses a so-called tooth-cleaning part comprising a woven or knitted base layer, which has the shape of a sleeve closed at one end, and a pile layer, which is supported by the base layer and which has filaments extending outward from the direction of the base layer, wherein the pile layer comprises a layer of loops woven or knitted to the base layer.

A disadvantage of the prior art is that a user whose fingers are too big or too small often has problems, since a device according to the prior art sits either too loosely or too tightly on the finger and, in either case, threatens to slip off the finger. In addition, the finely woven cloth forms a good shelter for bacteria or the like which, during later uses of the device, can be applied again to the gums or to any wounds present on the gums.

The problem addressed by the present invention is that of making available a device for cleaning the oral cavity, which device cannot easily slide off the finger and also remains hygienic after a number of uses.

### SUMMARY OF THE INVENTION

The solution to this problem lies in the basic form having a securing means.

A device according to the invention for cleaning the oral cavity can be produced from various materials. In the present illustrative embodiment, the materials used are microfiber fabrics.

Microfiber here is a term for fibers whose individual filaments are produced from a polyester/polyamide mixture and are finer than 1 denier. Fine silk, for example, has ca. 1.24 denier. Most microfibers are from 0.5 to 0.6 denier. The individual filament of the used fibrous fabric is only one hundredth of the diameter of a human hair. As the fibers are so small, many of them can be packed together, which results in a larger filament surface.

Microfiber fabrics are extraordinarily soft and very effectively retain their shape. An important advantage of all microfiber textiles is their particularly strong absorbency. They take up five times as much water as conventional cotton fibers. This is an important property as regards use in the oral cavity. A very moist environment is present there on account of the water taken into the mouth by the user for cleaning purposes and on account of the saliva.

The antimicrobial efficacy of the textiles used is based on silver ions, which are firmly bound in the fiber polymer. The growth of bacteria is inhibited on bioactive textiles. The antimicrobial action only takes place directly on the textile and is not released. The use of the textile is therefore safe for the user.

The materials used are not to be regarded here as exhaustive. Instead, the important point is whether the materials used are able to fulfill the tasks expected of them. If this is the case, they are regarded as materials for the device for cleaning the oral cavity.

The tasks listed here are not exhaustive but given instead as examples. It will first be noted that a base layer must be formed from a flexible material which can be easily woven, knitted or similarly processed.

A pile layer is applied to the base layer. In this pile layer, importance is attached to other properties. It must primarily fulfill the following tasks. In addition to taking up liquids, it must especially exert an antimicrobial action and must be easy to clean after use.

Another possibility of inexpensive production as follows is likewise encompassed by the inventive concept. Two microfiber cloths are placed on top of each other and are punched to the desired shape and size using a punching blade with a U-shaped profile. At the same time, the punched edges are connected to each other by ultrasound welding techniques. The safety loop can also be attached during this work step. The now finished fingerstall is then turned inside out.

Another important aspect of the pile layer is that it must be easy to connect to the base layer. In the preferred illustrative embodiment, the securing means is attached to the basic form.

The manner in which the securing means is attached is unimportant. It is also not important for the securing means to be made of the same material as the base layer. This simply facilitates the processing and ensures the flexibility and stretchability of the securing means.

In the preferred illustrative embodiment, the securing means is designed as a loop and is pulled on over a middle finger. The inventive concept is also intended to cover other means of securing the basic form.

Thus, it is equally conceivable that two threads protrude from the basic form and are wound around the user's wrist or knotted there in order to prevent the device from sliding off when cleaning the oral cavity. The inventive concept is directed principally to protecting the device from sliding off the finger.

Moreover, the device E shown in the preferred illustrative embodiment is designed to be used on the index finger and middle finger of the right hand. Regardless of the illustrative embodiment, the inventive concept likewise covers the arrangement on any other finger. It is therefore unimportant which finger the basic form is placed on. It is also unimportant which hand is used to employ the device.

A design as a glove is also conceivable in principle, in which case, in addition to the basic form which can be integrated in one or more fingers, the rest of the glove is secured.

By securing the basic form, it is easier to exert sufficient force on the gum in order also to massage the latter.

In addition to use in humans, the inventive concept also covers use on animals.

Oral cavity designates not only the teeth, tongue, gums and intrabuccal space, but also all foreign objects in the oral cavity. For example, it is conceivable that the user will be able to use a specially adapted device in order to clean metal jewelry items located in the oral cavity or to polish gold or ceramic fillings.

### BRIEF DESCRIPTION OF THE DRAWINGS

Further advantages, features and details of the invention will become clear from the following description of preferred illustrative embodiments and from the drawing. The latter shows, in a single FIGURE, a device according to the invention for cleaning the oral cavity.

### DETAILED DESCRIPTION

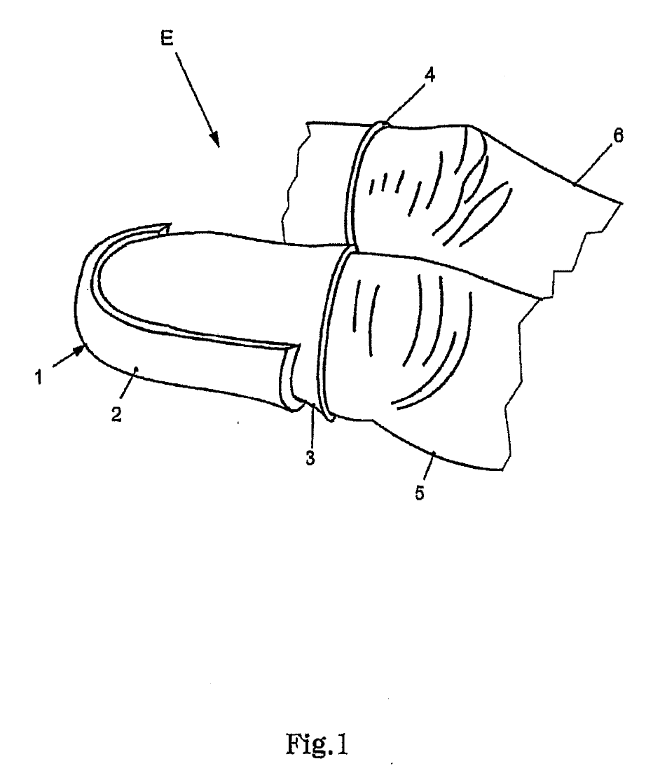

FIG. 1 shows a device E for cleaning the oral cavity. The device E consists of a basic form 1 and of a securing means 4. These are connected fixedly to each other at one location.

The basic form 1 in turn consists of a pile layer 2 and of a base layer 3. The base layer 3 is elastic. It extends under the pile layer as far as the end of the finger pad and encloses the latter in the manner of a thimble. In the preferred illustrative embodiment, the pile layer is arranged on the base layer to the height of the nail bed. The back of the finger is covered only by the base layer.

In the preferred illustrative embodiment, the securing means 4 is made of the same material as the base layer 3. It is flexible and shaped like a loop.

The function of the present invention is as follows. The user pulls the basic form 1 on over an index finger 5. In the preferred illustrative embodiment, this is the index finger 5 of the right hand.

The securing means 4 is pulled on over the middle finger 6 of the same hand.

The user can then insert the basic form 1, secured by the securing means 4, into the oral cavity and, by moving it to and fro, can thus clean the oral cavity, in particular the teeth.

1-5. (canceled)

6. A device for cleaning the oral cavity, comprising a basic form of a thimble, wherein the basic form has a securing means.

7. The device as claimed in claim 6, wherein the securing means is flexible.

8. The device as claimed in claim 6, wherein the securing means is designed as a loop.

9. The device as claimed in claim 6, wherein the basic form comprises a pile section and a base section, and the securing means is connected to the base section.

10. The device as claimed in claim 9, wherein at least the pile section is made of antibacterial cloth.
